(19) United States
(12) Patent Application Publication
(10) Pub. No.: US 2013/0024298 A1
(43) Pub. Date: Jan. 24, 2013

(54) SYSTEM AND METHOD FOR DISPLAYING ADVERTISING

(71) Applicants: William Irvine, Phoenix, AZ (US); Mark Allin, Comanche, OK (US)

(72) Inventors: William Irvine, Phoenix, AZ (US); Mark Allin, Comanche, OK (US)

(73) Assignee: ADSESSION CORP., New York, NY (US)

(21) Appl. No.: 13/553,719

(22) Filed: Jul. 19, 2012

Related U.S. Application Data
(60) Provisional application No. 61/509,418, filed on Jul. 19, 2011.

(51) Int. Cl. G06Q 30/02

(52) U.S. Cl. 705/14.73

(57) ABSTRACT

A system having a delivery visualization module configured to allow a user to review one or more prioritization parameters and prior advertisement delivery data, the delivery visualization module is further configured to allow the user to adjust the one or more prioritization parameters; a yield tracking module configured to allow the user to enter information into the system related to the one or more prioritization parameters and the prior advertisement delivery data; an optimization module configured to create an ordered list of two or more advertisement networks based on the one or more prioritization parameters; and a delivery module configured to determine, based on the ordered list of the two or more advertisement networks, at least one advertising network of the two or more advertisement networks to provide at least one advertisement to display at a first web page of a web site. Other embodiments are disclosed.

### CROSS-REFERENCE TO RELATED APPLICATIONS

This application claims the benefit of U.S. Provisional Application No. 61/509,418, filed Jul. 19, 2011. U.S. Provisional Application No. 61/509,418 is incorporated herein by reference.

### FIELD OF THE INVENTION

This invention relates generally to systems and methods for displaying advertising, and more particularly, to systems and methods to facilitate display of two or more advertisements at one or more web sites.

### DESCRIPTION OF THE BACKGROUND

The majority of all Internet traffic is devoted to web sites that fall into a category popularly described as “Long-Tail” that receive less than one million unique monthly visitors. These Long-Tail web sites often struggle to survive, primarily because revenue generation can be difficult for a number of reasons, which include: 1) little to no interest from major Internet advertisers; 2) minimal or no interest from advertising networks; 3) the operators/owners have minimal or no experience in managing the advertising they are able to obtain; 4) it can be difficult to manage more than one advertising network; and 5) the operators/owners rarely have the time or ability to continually monitor the performance of advertising they are able to obtain. The result is that vital resources of online independent thought, free expression, or new Internet businesses representing significant new ideas are in danger of not realizing the revenue necessary to maintain operations.

Accordingly, a need or potential for benefit exists for a system or method that provides advertising (and the related revenue) to Long-Tail websites.

### BRIEF DESCRIPTION OF THE DRAWINGS

To facilitate further description of the embodiments, the following drawings are provided in which:

FIG. 1 illustrates a block diagram of an exemplary computer system, according to some embodiments;

FIG. 2 illustrates an overview of the computer system of FIG. 1, according to some embodiments.

FIG. 3 illustrates an exemplary yield tracking data entry form;

FIG. 4 illustrates an exemplary yield tracking visualization showing revenue performance for the previous thirty days;

FIG. 5 illustrates an exemplary delivery visualization showing actual ad impressions for current and prior days;

FIG. 6 illustrates an exemplary delivery visualization showing actual ad network impression in real time against prior days and periods;

FIG. 7 illustrates an exemplary optimization form used to define the parameters from the optimization process;

FIG. 8 illustrates an exemplary optimization process, according to an embodiment.

FIG. 9 illustrates an example of an hard-coded file for one of the ad sizes;

FIG. 10 illustrates an example of a method used to deliver an optimized Internet advertisement;

FIG. 11 illustrate an exemplary Java Script ad tag;

FIG. 12 illustrates a computer that is suitable for implementing an embodiment of computer system of FIG. 1; and

FIG. 13 illustrates a representative block diagram of an example of the elements included in the circuit boards inside chassis of the computer of FIG. 12.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

In some embodiments, Internet advertisers can be brands (and/or their agencies) that create and pay for online advertising campaigns. In some embodiments, advertising networks can be providers of dozens or hundreds of online advertising campaigns from Internet advertisers. In some embodiments, optimization providers can attempt to manage dozens (or more) advertisers and advertising networks to maximize the potential revenue realized by web sites from each individual Internet advertisement. In some embodiments, display ads can refer to online advertising that use images, animations, video, and/or other non-text formats. In some embodiments, open source software can refer to collaboratively-built web applications that are typically free to acquire. In some embodiments, an ad server can be a web application designed to deliver, track, and report on online display advertising campaigns. In some embodiments, web usability can be the heuristic science of understanding how people interact with web sites and other online content. In some embodiments, human/computer interaction also can be a heuristic science, but focuses on the broader problem of people using entire computer systems, components, and/or software. In some embodiments, a decision layer within a web application can be defined as any collection of processes that use available data, combined with programming logic, to deliver a dynamic result.

### DETAILED DESCRIPTION OF EXAMPLES OF EMBODIMENTS

Some embodiments disclose a system configured to determine two or more advertisements to be displayed at one or more web sites. The system is further configured to be performed using one or more central processing units. The system having: (a) a delivery visualization module configured to allow a user to review one or more prioritization parameters and prior advertisement delivery data, the delivery visualization module is further configured to allow the user to adjust the one or more prioritization parameters; (b) a yield tracking module configured to allow the user to enter information into the system related to the one or more prioritization parameters and the prior advertisement delivery data; (c) an optimization module configured to create an ordered list of two or more advertisement networks based on the one or more prioritization parameters; and (d) a delivery module configured to determine, based on the ordered list of the two or more advertisement networks, at least one advertising network of the two or more advertisement networks to provide at least one advertisement to display at a first web page of a web site of the one or more web sites. The two or more advertisements comprise the at least one advertisement.

The same or different embodiments disclose a system configured to facilitate display of two or more advertisements at one or more web sites. The system can be configured to run on a server. The system can include: a first module configured to create a first ordered list of the two or more advertisements, the first module is configured to store the first ordered list of the two or more advertisements in a memory of the server; and a second module configured to determine which of the two or more advertisements to display at the one or more web sites based on the first ordered list of the two or more advertisements.

Other embodiments disclose a method to facilitate display of two or more advertisements at one or more web sites. The method can include: using a server to create a first ordered list of the two or more advertisements; storing the first ordered list of the two or more advertisements in a memory associated with the server; and using the server to determine which of the two or more advertisements to display at the one or more web sites based on the first ordered list of the two or more advertisements.

Still other embodiments disclose a method to determine two or more advertisements to be displayed at one or more web sites. The method can include: facilitating entering into a server information related to one or more prioritization parameters and prior advertisement delivery data; facilitating review by a user of the one or more prioritization parameters and the prior advertisement delivery data on the server; facilitating adjustment of the one or more prioritization parameters; using the server to create an ordered list of two or more advertisement networks based on the one or more prioritization parameters; and using the server to determine, based on the ordered list of two or more advertisement networks, at least one advertising network of the two or more advertisement networks to provide at least one advertisement to display at a first web page of a web site of the one or more web sites. The two or more advertisements comprise the at least one advertisement.

Business models have emerged from a number of optimization providers (such as the Rubicon Project, Pubmatic, Inc. and AdMeld, Inc.) that attempt to quantify the individual performance of advertising networks (such as Advertising.com, ValueClick, Inc., Tribal Fusion, etc.) and provide web site operators with the best-paying advertising in real-time. However, due to the enormous scale and expense of such an undertaking (e.g., there can be as many as one hundred advertising networks being tracked), these optimization providers do not offer their services to Long-Tail web site operators, and instead focus on high-traffic, high-value web properties.

Furthermore, Long-Tail web site operators who have obtained advertisements from more than one provider of network advertising often do not attempt to prioritize the delivery of the display ads for maximum revenue, or they rely on open source or inexpensive ad server software in an attempt to manage monthly revenue yield. The problem with such ad server software is that the core system is designed to deliver specific paid advertising banners, not manage the priority and frequency of advertisements from providers such as advertising networks.

Another shortcoming of available solutions, both from optimization providers and ad server software, is one of “latency.” In this context, latency is the amount of time a computer programmed to deliver web content (e.g., a web server) takes to actually deliver the content to the end user, whether in the form of words, images, or advertisements on a web page. Latency may come from numerous sources because a typical web page can assemble content from more than one web server, and can be affected by the performance and sophistication of the computer software on that server, the processing power of the server, the number of web users receiving pages from that server, and the speed of the network connection of the server. In some cases, the cumulative latency of a given web page can exceed one second or more, thereby slowing down the perceived speed of the web page to the end user. Several studies on web usability and human/computer interaction have concluded that the vast majority of web site users make cognitive decisions on what to do next (e.g., click a link, read content, etc.) within the first 3.6 seconds of visiting a web page. Therefore, latency associated with the display of Internet display advertising can have a significant adverse effect on the actual revenue potential.

In order to “decide” which advertisement to display, existing systems rely on database software of varying levels of performance and sophistication. This reliance introduces a decision-layer within the optimization software system that must first recognize a given Internet user, determine which advertisements the Internet user has already viewed, determine which advertisement is appropriate to view next, and then execute the programming to select and record the next advertisement delivered to the user. For Long-Tail web site operators who attempt to install and use available advertisement serving software, the resulting latency specific to the display of optimized Internet advertisements can often exceed one second, primarily because the operators do not have access to high-performance computer hardware. As previously discussed, this delay has the potential to significantly impair both the performance of the advertisement (e.g., the end user “sees” the advertisement late in their cognitive process) and the earned revenue of the advertisement.

Another disadvantage of existing systems and methods (e.g., both systems and methods used by web site operators attempting to use an ad server, and optimization providers) is a reliance on the performance reporting, insofar as earned revenue, from the advertising networks in order to define the optimal mixture of Internet advertisements from those networks. In some embodiments, the performance reporting of advertising networks can provide web site operators with access to daily reports that show the number of advertisements displayed, and the revenue earned.

Because the data from the advertising networks may be delayed up to 24 hours (or more), optimization decisions are based on yesterday's data at best. If an advertising network were to begin a new high-volume campaign from a high-dollar advertiser, the existing systems will not be aware of a sudden increase in ad revenue and/or available advertisement impressions until after it has happened. The result, for operators of web sites using solutions from current optimization providers, is that revenue opportunities are missed because the current systems react to advertisement revenue, rather than anticipate advertisement revenue. This reactive stance is due primarily to the optimization provider's attempts to integrate dozens of advertising networks, making proactive anticipation of high-paying advertisements nearly impossible because of the scale of the problem.

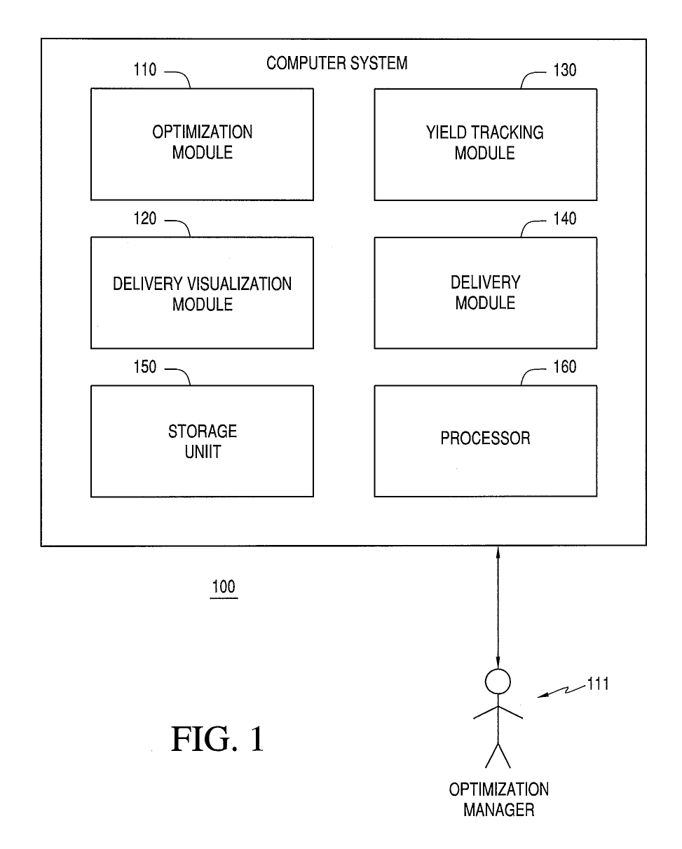

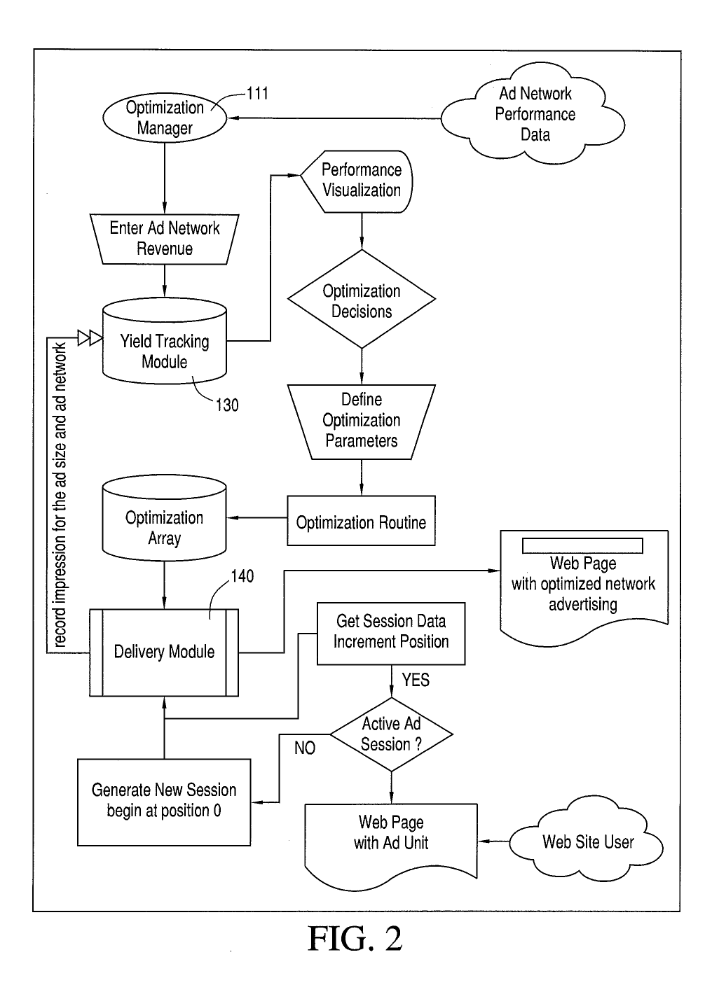

Turning to the drawings, FIG. 1 illustrates a block diagram of an exemplary computer system 100, according to some embodiments. FIG. 2 illustrates an overview of computer system 100, according to some embodiments. Computer system 100 is merely exemplary and is not limited to the embodiments presented herein. Computer system 100 can be employed in many different embodiments or examples not specifically depicted or described herein. Computer system 100 can be designed to eliminate the latency associated with the decision-layer, and can employ proactive optimization by:
Deploying a “hard-coded” instance of an advertisement optimization system with a predetermined optimization sequence that does not rely on a database system, and does not employ a decision-layer processes in order to display an advertisement;
Providing a “delivery module” that takes advantage of the predetermined optimization to deliver advertisements and eliminate the latency associated with optimization of advertisements;
Enabling operators of embodiments of computer system 100 to make adjustments that can be instantly applied to all advertisements using computer system 100 and to all users of web sites using computer system 100;
Offering a method whereby fluctuations in advertising network revenue may be both tracked and anticipated, providing a “proactive optimization” option; and
Utilizing a smaller list of premium advertising networks with open communication protocols to inform the system of future high-paying advertising campaigns.

The result of computer system 100, as shown in FIGS. 1 and 2, can be a significantly more efficient system, which requires less hardware to deploy than existing systems, thereby enabling a cost-effective solution specifically to optimize the delivery of network advertising. The resulting efficiency provides for a cost-effective system targeted for the tens-of-thousands of Long-Tail web sites whose traffic levels do not qualify for service from current optimization providers.

Access to the Internet requires one of several types of devices: a computer, a tablet device, or a mobile smart phone, for example. Each device makes use of a web browser that converts HTML (hyper-text markup language) or other web content that describes a web page into a user-friendly, viewable presentation. Web browsers can be, for example, the Internet Explorer web browser by Microsoft Corporation, the Firefox web browser by Mozilla Corporation, the Opera web browser by Opera Software ASA, the Chrome web browser by Google, Inc., or the Safari web browser by Apple Corporation. In some embodiments, HTML can be the core Internet mark-up language that defines the structure and content of web pages. In some embodiments, JavaScript can be a scripting language, which can be included within an HTML document, and is executed by the web browser.

The HTML of a typical web page can contain multiple elements such as paragraphs of text, images, interactive JavaScript code, and many other “assets.” Most web pages contain small pieces of JavaScript code (or another type of code) known as an ad tag that requests an Internet advertisement from one or more advertising networks, and displays the advertisement on the web page. In some embodiments, each advertising network can employ its own JavaScript ad tag that interfaces with its system to display ads. The ad tag provides the advertising network with basic information, such as the web site's identifier, size of the ad, position of the ad, etc. Software on the web servers operated by the ad network process the information, and return back to the web site, what is determined to be an appropriate Internet advertisement. There are dozens of advertising networks, each with their own mixture of advertisers who can pay anywhere from $2.00 to $0.02 per one thousand views of their ads.

When computer system 100 is employed, the web page owner can replace its ad tags with the ad tags of computer system 100, which accesses the hard-coded instance of computer system 100 to select the ad tag from a pre-optimized list that is most likely to earn the web site operator the most revenue.

One of the core revenue-sharing concept of embodiments of computer system 100, as it relates to paying participating web site operators, is to “pool” the available advertising impressions of dozens (or more) of high-quality Long-Tail web sites for a highly-significant representation of millions of web site end users. Computer system 100 can create a pre-sorted list of available network advertising with weighted priority applied to providers of the highest-paying ad impressions, from a select group of, for example, a dozen providers of network advertising, with no noticeable latency. The resulting revenue pool is shared, each month, with each participating Long-Tail web site proportionate to the Internet traffic its web site has contributed to the pool. The operator of computer system 100 retains a percentage of the pool to fund operations and support the infrastructure necessary to deliver computer system 100. In some embodiments, the revenue pool can be the total of ad revenue earned by all web sites participating in computer system 100.

Computer system 100 can include: (a) an optimization module 110; (b) a delivery visualization module 120; (c) a yield tracking module 130; (d) a delivery module 140; (e) at least one storage unit 150 (e.g., a database system); and (f) at least one processor 160.

Optimization module 110 can be configured to create an ordered list of two or more advertisement networks based on one or more prioritization parameters. Delivery visualization module 120 can be configured to allow a user to review one or more prioritization parameters and prior advertisement delivery data, and can be further configured to allow the user to adjust the one or more prioritization parameters. Yield tracking module 130 can be configured to allow the user to enter information into computer system 100 related to the one or more prioritization parameters and the prior advertisement delivery data. Delivery module 140 can be configured to determine, based on the ordered list of advertisements (or advertisement networks), at least one advertisement network to provide at least one advertisement to display at a web page.

In some embodiments, an optimization manager 111 can be the person responsible for the day-to-day management of computer system 100, updating data, communicating with advertising networks, and making optimization decisions. In other embodiments, optimization manager 111 can be an automated or semi-automated routine run by an computer server. Optimization manager 111 can utilize the reporting consoles of the participating advertising networks and enter the daily earnings, for each ad size/position, into yield tracking module 130. Optimization manager 111 can then review performance through delivery visualization module 120, review communications from the advertising networks regarding upcoming high-value campaigns, and make necessary adjustments to the delivery and priority of network advertising used by optimization module 110. In some examples, optimization module 110 then effectively generates a new hard-coded instance of optimized array of advertising networks and delivery code based on the parameters entered in the optimization method described below. This hard-coded instance of the list of advertising networks creates a mechanism whereby the decision layer is predetermined, reducing latency to near-zero. In some embodiments, hard-coded can refer to the concept of a self-contained web application stored on the computer server without any need for external data, other than what is coded into the application at the time it is created. In other examples, hard-coded refers to a semi self-contained web application on the computer server that can use external data.

Computer system 100 can take two forms: managed and on-demand. The managed version can utilize the revenue pool described above and is administered by optimization manager 111. The on-demand version can be a SaaS (software as a service) solution for web sites that may not qualify for the revenue pool of the managed version—web site operators enter their own ad network providers and optimize their own delivery. Both systems can be implemented using, for example, the LAMP (Linux, Apache, MySQL, PHP) framework and are functionally identical; however, any system configured to deliver web applications (such as Java, Microsoft .NET, ColdFusion, etc.) could be used.

Computer system 100 can be efficient in terms of code overhead (i.e., the lines of code required to operate) and the avoidance of using a database-reliant decision-layer in order to select the next Internet advertisement to display. As a result, the efficiency translates to three primary advantages:
Computer system 100 can operate on inexpensive server hardware—previously impractical with prior art optimization systems;
Computer system 100 can accommodate a high number of active web sites on advanced server hardware—previously requiring sophisticated clusters of high-end server hardware and dedicated personnel; and
Computer system 100 operates with an effective latency of zero, thereby improving the efficiency of advertisements and the operation of web sites using computer system 100—previously Long-Tail web site operators were concerned that they have been forced to limit the number of ads on each page.

The efficiency of the method to display advertisements—using a hard-coded presorted list of optimized advertisements from third-party network advertising suppliers—solves the problem differently than prior art methods.

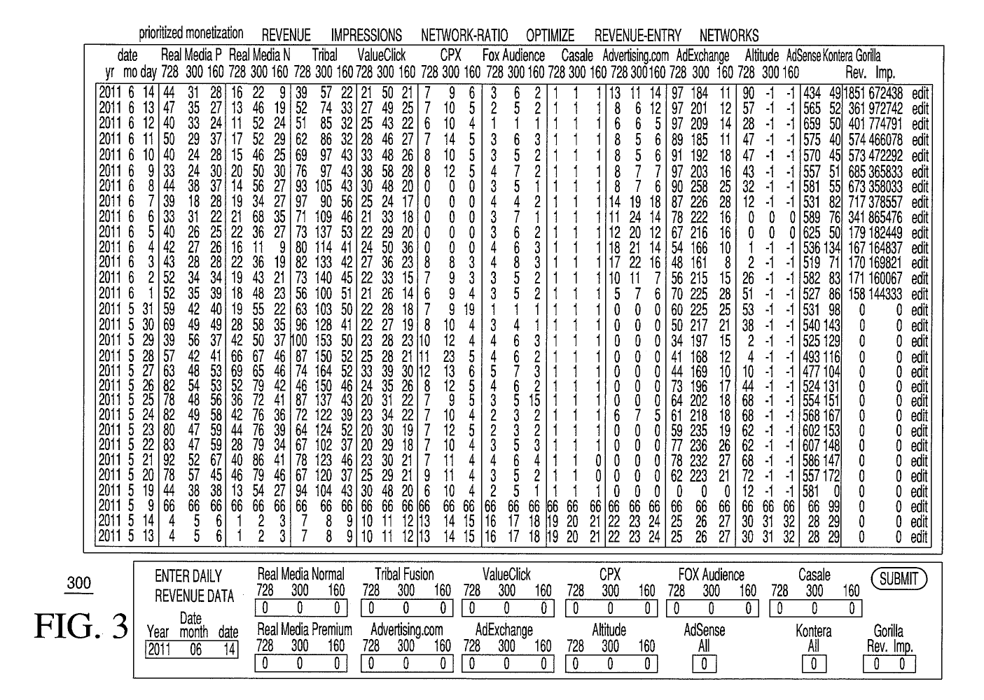

In some examples, optimization manager 111 employs yield tracking module 130 to enter the advertising networks' performance for predetermined time (e.g., a previous day, previous week, previous month, or previous hour) into storage unit 150 for retention (see FIG. 3). FIG. 3 illustrates an exemplary yield tracking data entry form 300. Yield tracking module 130 requires accurate information on the actual revenue generated by each ad size from each ad network provider. Yield tracking module 130 also includes the ability to enter information for storage in tables/databases of storage unit 150 with fields for any source of advertising (e.g., direct-sell or Google AdSense) not included in the optimization method to allow optimization manager 111 to view all revenue sources for comparison and reporting purposes. Data entered can be stored in storage unit 150, configured to, for example, retain one row of data, on each column of information, for each day.

While Internet advertisements can take a wide variety of shapes and sizes, the most popular formats provided by third-party advertising networks typically fall into one of three primary aspect ratios:
“Leaderboard”: are ads in the shape of a horizontal rectangle that fall into one of two primary pixel dimensions, 728 pixels wide by 90 pixels tall and 468 pixels wide by 60 pixels tall.
“Rectangle”: are ads in the shape of a near-square, and are 300 pixels wide by 250 pixels tall.
“Skyscrapers”: are ads in the shape of a tall vertical rectangle and fall into one of two primary sizes, 160 pixels wide by 600 pixels tall and 120 pixels wide by 600 pixels tall.

These most-popular sizes provide web site developers with creative options for the layout of their web pages and the placement of ads so as to both compliment the content, and draw attention to the advertising for the generation of revenue. Advertising networks typically provide revenue reports (i.e., the cost per advertisement) for each size in the form of CPM, or the cost per thousand impressions of the advertisement. Most advertising in the form of display ads that fit these sizes are bought and sold based on the CPM model.

The majority of the advertising networks have a finite inventory of advertisements available to any given end user on any given day. As a result, very-active end users may experience all the advertisements an advertising network has to offer, resulting in either blank or public service ads once the end user receives all the available ads. The result is a fill rate less than 100%. For example, if a web site experiences 100,000 views of their pages in one day with an ad tag from a given advertising network, but that network is able to deliver only 75,000 ads to the end users, the resulting fill rate is 75%.

That same ad network may have sold each of its 75,000 advertisements at a $1 CPM, earning $75 on the day, but 25,000 impressions received no income. Because the advertising networks usually share the revenue with the participating web sites with, for example, a 50/50 split, the amount paid to the web site is half of $75, or $37.50.

The eCPM (earned-CPM or effective-CPM) realized by the web site, in this example, is actually $0.375 on the entire 100,000 impressions made available to the advertising network. While the reporting system of the network can report a gross CPM of $1.00 on the ads it displayed (or a CPM of $0.50 if it reports net revenue), the important number for web site operators is the eCPM number of $0.375.

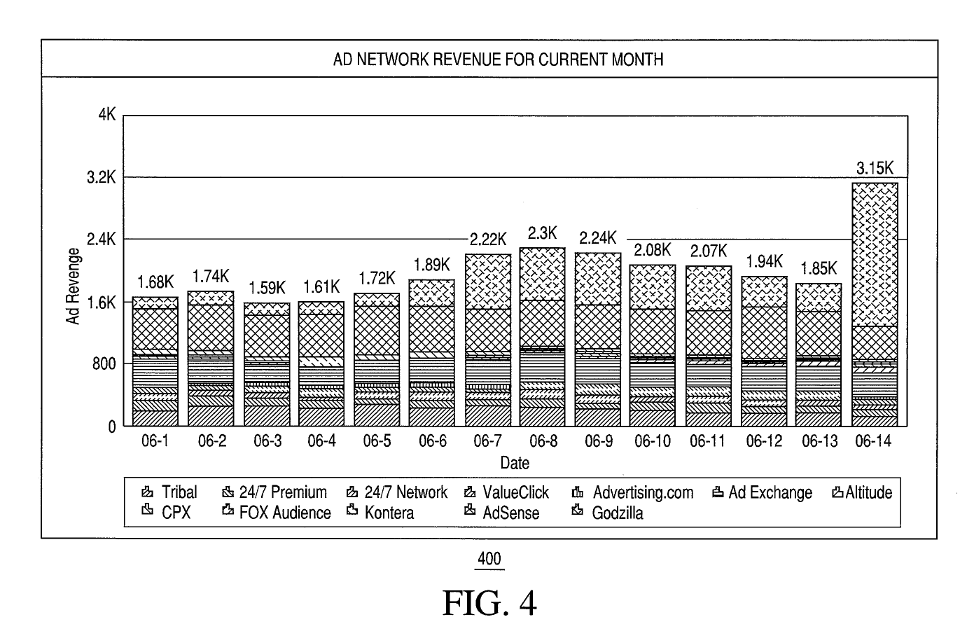

In some embodiments, yield tracking module 130 can utilize the eCPM number, and includes a performance visualization (see FIG. 4) that enables optimization manager 111 to review prior performance and compare the results of daily optimization, using actual net ad revenue earned, in an easy-to-comprehend visual graph. FIG. 4 illustrates an exemplary yield tracking visualization 400 showing revenue performance for the previous thirty days.

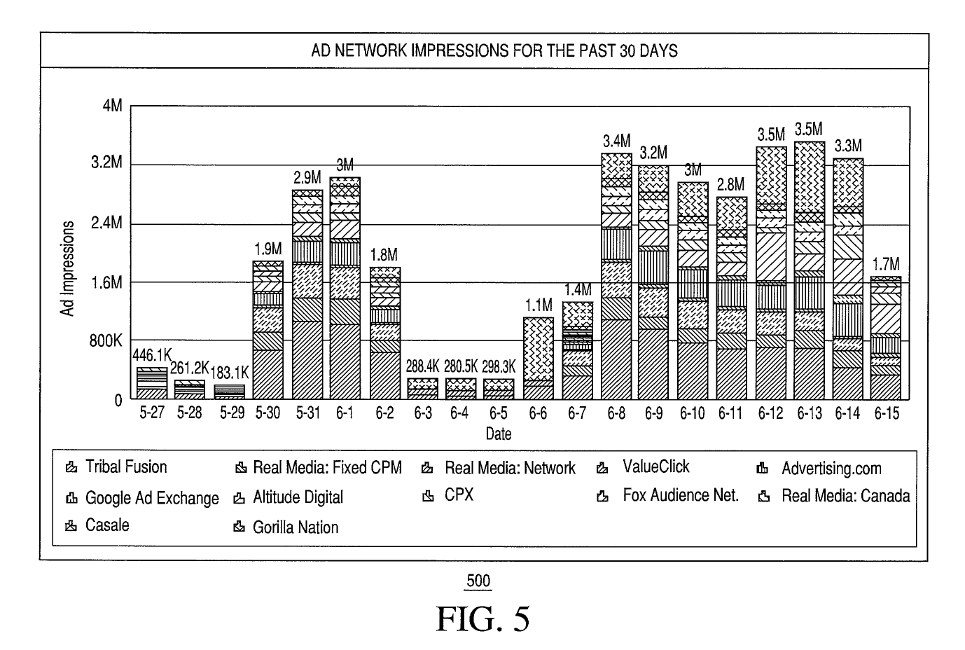

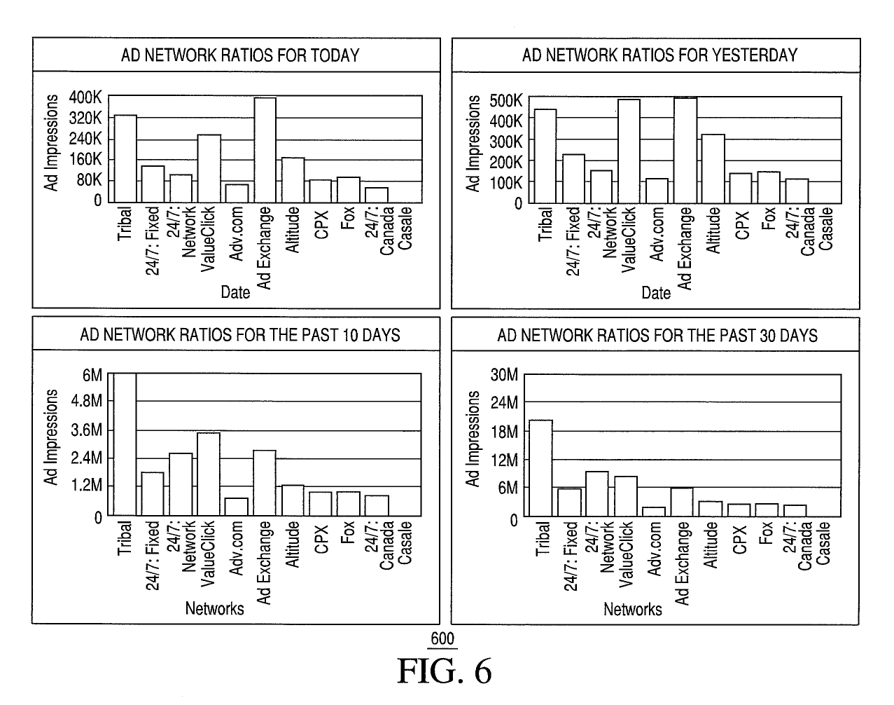

Delivery visualization module 120 can log each delivered impression of each size of each network advertisement in the database as cumulative daily totals. Optimization manager 111 can have, for example, two visual tools to review the delivery of advertisements, one for a 30-day look at advertisement impressions (see FIG. 5), and another that compares the current day's delivery of each ad network against previous days (see FIG. 6). Both visualization tools are useful for the review of the real-time performance of optimization settings. FIG. 5 illustrates an exemplary delivery visualization 500 showing actual ad impressions for current and prior days. FIG. 6 illustrates an exemplary delivery visualization 600 showing actual ad network impression in real time against prior days and periods.

The graphs can combine logged impression information from storage unit 150 for a visualization of actual advertisement delivery. Optimization manager 111 can use these tools to confirm the proper execution of the optimization settings.

The retention and logging of actual ad impressions can be used in the calculation of the actual observed net eCPM for each ad size from each network. After optimization manager 111 enters, for example, the previous day's revenue from each network, computer system 100 then calculates the observed net eCPM for each, and includes those in the visualization graphs and performance reports.

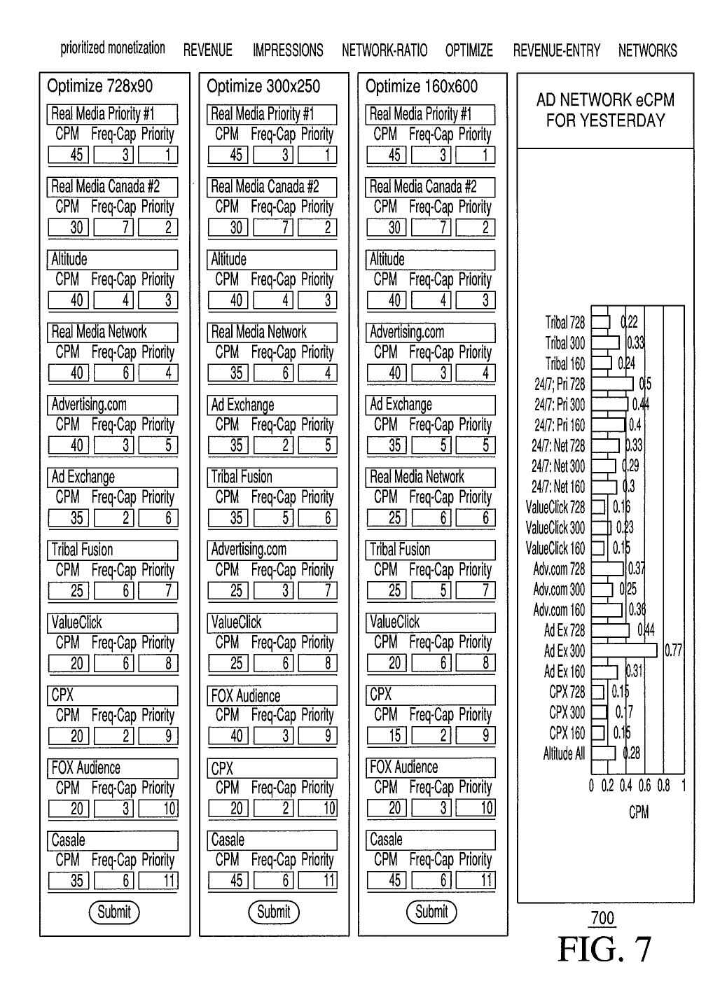

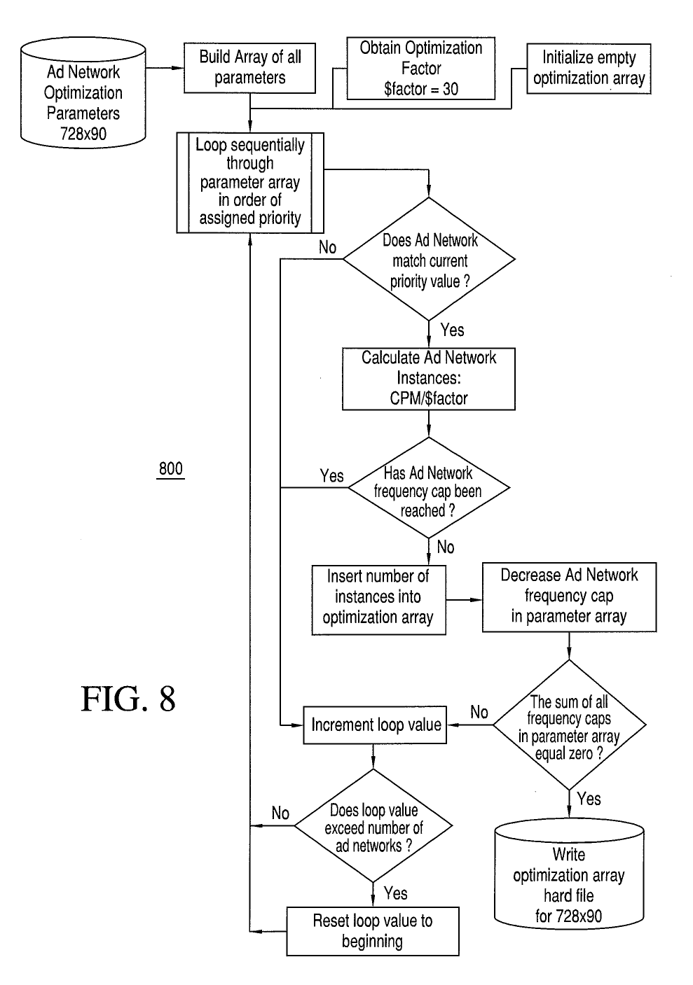

Once optimization manager 111 has entered, for example, the prior day's earned revenue from each of the advertising networks, he can then use, for example, the Optimization Form (see FIG. 7) to refine several parameters used by computer system 100. FIG. 7 illustrates an exemplary optimization form 700 used to define the parameters from optimization process 800 of FIG. 8. As the form is presented to optimization manager 111, computer system 100 uses the available data to make “suggestions” on each of the optimization parameters, or, if optimization manager 111 so chooses, offer the previously entered optimization parameters.

The optimization parameters for each ad size from each advertising network, for example, can be:
CPM—In some embodiments, entered as cents and depending on the discretion of optimization manager 111 can be the actual eCPM for the ad size, or some other number;
Frequency Cap—In some embodiments, the limit on the number of ads a web site user will see for that ad size from that advertising network in a 24-hour period;
Priority—In some embodiments, the optimization priority, “1” being highest, for each ad position from each advertising network in some embodiments; and
Fill-Rate—In some embodiments, the fill rate from each network for each ad size.

Within the optimization form, optimization manager 111 also has a visualization tool available that provides the prior day's “eCPM” performance of each ad position from each advertising network.

Optimization manager 111 can use this information, as well as any previously provided information from the advertising networks on currently running campaigns, to refine the priority, frequency cap, and CPM of each ad position from each advertising network. Typical optimization decisions can include:
Revenue Performance: If the observed revenue (based on observed net eCPM) from a specific ad size from an advertising network fluctuates downward, optimization manager 111 can reflect the new eCPM in the optimization form, as well as adjust the frequency cap downward to reflect the decrease in performance. This modification will provide more impressions for better-performing ads. Likewise, if the observed eCPM were to increase, optimization manager 111 can update the new value and increase the frequency cap. These modifications can provide more impressions for a better-paying ad.
Revenue Priority If the observed revenue fluctuates significantly (e.g., typically more than $0.10 eCPM), in either direction, optimization manager 111 can review the performance of ads higher and/or lower in the priority sequence. If an ad size is showing significant performance increases, the optimization manager 111 can set the priority value lower (indicating a higher, top-priority position) to move the ad unit close to the top of the optimization form. Likewise, significant drops in revenue performance can result in a higher priority value (lower-priority position).
Scheduled Changes One of the advantageous aspects of the optimization process can be the ability to plan for the beginning of, or the end of, high-volume and/or high-value campaigns from one or more advertising networks. Whenever a representative of a network alerts optimization manager 111 to such a campaign, adjustments to the CPM, frequency cap, and priority can be made to accommodate the improved revenue at the start of a campaign, and return settings to normal at the end.
Fill-Rate and Ad Network CPM: Some advertising networks can have a low fill-rate of less than 60%, but report a high CPM on the ads they fill. Optimization manager 111 can assign a CPM in the optimization form higher than the eCPM observed, and attempt to refine the frequency cap in an effort to improve the fill rate and take advantage of the higher CPMs available at the advertising network.

When optimization manager 111 submits form 700 of FIG. 7 for each ad size, optimization module 110 can use the data to generate a predefined prioritization array of advertising networks, for that size ad, prioritized for maximum revenue yield. The array, and associated information, can be then written as a file to the system, and thereby generating a new hard-coded instance of delivery module 140.

FIG. 8 illustrates an exemplary optimization process 800, according to an embodiment. In some embodiments, optimization module 110 of FIG. 1 can perform at least part of these activities. Optimization process 800 is merely exemplary and is not limited to the embodiments presented herein. Optimization process 800 can be employed in many different embodiments or examples not specifically depicted or described herein. In some embodiments, the activities, and/or the procedures of optimization process 800 can be performed in the order presented. In other embodiments, the activities and/or the procedures of optimization process 800 can be performed in any other suitable order. In still other embodiments, one or more of the activities, the procedures, and/or the processes in optimization process 800 can be combined or skipped.

In some examples, the optimization process 800 cycles through each ad size from each advertising network to assemble the prioritization array. The “$factor” can be used to determine the ability for high-CPM ads to repeat sequentially in the final optimization array. In some examples, optimization manager 111 can opt for a factor of 30, which means any ad size with a CPM higher than $0.30 will repeat twice, sequentially in the array. In other examples, other factors such as 1, 10, 20, 40, 50, 100, or 1,000 can be used.

For the purposes of demonstration, the illustrated optimization process creates an optimization array for the 728×90 (leaderboard) ad size. Optimization process 800 relies on the priority value, the frequency cap, and the CPM, each of which is assigned via the prioritization form 700 of FIG. 7. Optimization module 110 assembles an array of the optimization parameters, the size of which is equal to the number of ad networks being optimized. Cycling through the array of parameters multiple times, the optimization method decreases the frequency cap for an ad network by one each time an instance of the networks is placed in the optimization array. Once the sum of all frequency caps in the parameter array equals zero, the optimization process finishes and writes the optimization array hard file on storage unit 150.

Optimization process 800 can factor each variable, giving priority to advertising networks with a higher CPM and frequency cap, creating an array of advertising network impressions, the total of which is equal to the cumulative total of frequency caps defined in the optimization form. Knowing that advertising networks seek to optimize their own delivery—providing higher-paying ads first—optimization process 800 does not exhaust all impressions (as defined by the frequency cap) from each advertising network before moving on to the next. Instead, optimization module 110 seeks to cycle through each available advertising network in building the array, in a prioritized rotation, until all available impressions are exhausted.

The factor value can be one of the important aspects of optimization process 800. The purpose of the factor value is to allow for multiple sequential occurrences of an advertising network's ad tag when that network's CPM (as defined by optimization manager 111 or optimization module 110) is multiples of magnitude higher than the value assigned to the factor.

If an ad has been assigned a CPM that is three times higher than the factor, for example, optimization module 110 can place it three times, in sequence, into the optimization array if there are enough impressions available as defined by the frequency cap.

If an ad has been assigned a CPM that is less than the factor, for example, optimization module 110 can insert it once each time the code is executed, until the impressions as defined by the frequency cap are exhausted.

Adjustments to the cap allow optimization manager 111 to fine tune the entire optimization process based on the current CPMs defined in the optimization form 700 of FIG. 7. For example, if all of the CPMs for all ad positions are relatively low (e.g., less than 50), optimization manager 111 can set a cap of 25 so that the higher-paying ads have more opportunity to appear. Likewise, if one or more ad networks are showing CPMs at or above 80, optimization manager 111 can set the cap to 40 to give priority to the higher paying ads, while still effectively cycling through the lower paying ads.

The result of optimization process 800 of FIG. 8 can be a hard file written to storage unit 150, and is the core component of delivery module 140. The example of an actual file shown below defines the core optimization variables (defined by the optimization form) that are used to review the status of the most recent optimization settings, and the actual optimization array as “$opt_array” that contains the indicators for each advertising network in the order that has been defined by the optimization process.

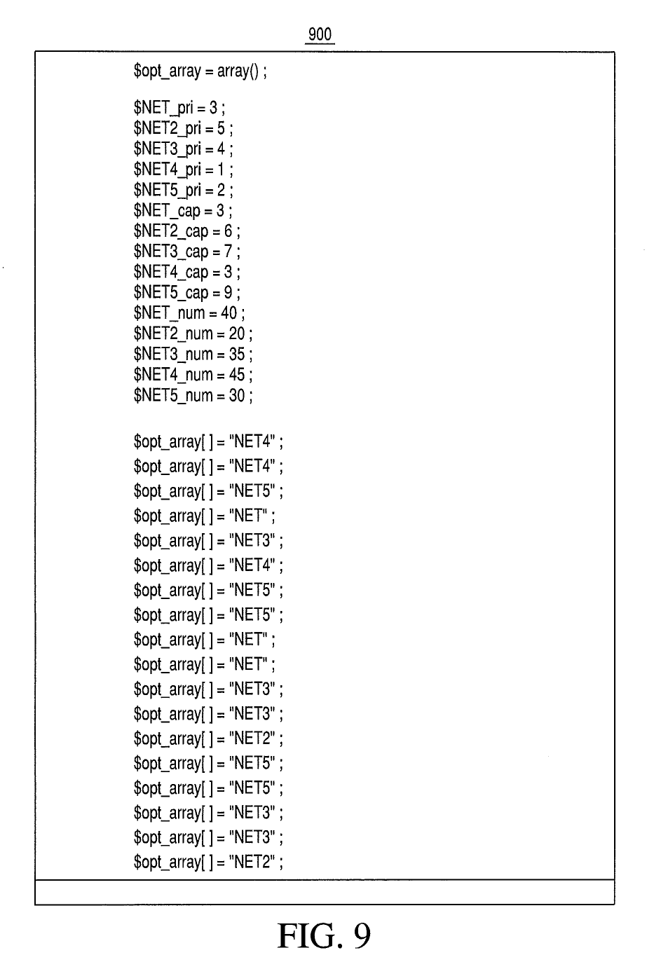

FIG. 9 illustrates an example of an actual file for one of the ad sizes, containing the hard-coded values for five different advertising networks, shown as “NET,” “NET2,” “NET3,” “NET4,” and “NET5.” Each of the three optimization variables for the networks are defined in the file, as well as the optimization array, with the optimization sequence. Delivery module 140 can use the $opt_array to determine which ads to show to each user, in the predefined optimized sequence.

Yield tracking module 130 and optimization modules 110 allow for scheduled automated optimization, based on timing as defined by optimization manager 111 through the use of an automated CRON job on the server (a module for performing a CRON job is a standard part of operating systems used for web applications). When automated updates are available from advertising networks, such as revenue, impressions, CPM, etc., the updates are integrated into yield tracking module 130 (e.g., via an API call to the advertising network's reporting system). In some embodiments, API stands for “application programming interface” and is a common framework for allowing external applications or processes to have authenticated access to a web or other application.

The automated process can look for any change in eCPM during the current day, revises the parameters stored in the hard file, and runs optimization process 800 of FIG. 8.

In some embodiments, advertising networks can inform computer system 100, through an automated addition to their reporting system's API, as to the timing and value of new high-yield or high-inventory advertising campaigns. This capability can be integrate with computer system 100 as follows:
The advertising network's reporting system can allow periodic queries from computer system 100 through their secure API. For example, computer system 100 can query once every six hours.
The advertising network can return information (e.g., available inventory, scheduling, CPM, ad sizes, etc.) on their top-paying campaigns targeted to web sites in the AdSession web site pool.
At each automated optimization interval, if there are available high-value ad campaigns from an advertising network, the frequency cap, priority, and CPM can be automatically increased to take advantage of the new campaigns.
During subsequent automated optimization intervals, the optimization method can also compare the schedule of high-value campaigns and determine if those campaigns have ended, and accordingly adjust the optimization values.

Delivery module 140 uses the pre-defined prioritization parameters of the optimization array integrated into a hard-coded instance to deliver advertisements to web site end users with no noticeable latency.

In one example, delivery module 140 can utilize a core component of the PHP/Apache framework, session variables, to recognize and identify each individual web site user. A new visitor can be, for example, assigned a random and unique alphanumeric session identifier and stored as a cookie (e.g., “adsession_X” where X defines the computer server being used) by their computer's web browser. Upon the user's first ad impression, the value defined by the cookie is zero, for example, and the user is given the first ad in the prioritization array created by optimization process 800. Upon the second ad impression, the value defined by the cookie is incremented by one, for example, and the user is given the second available ad as defined by the prioritization array.

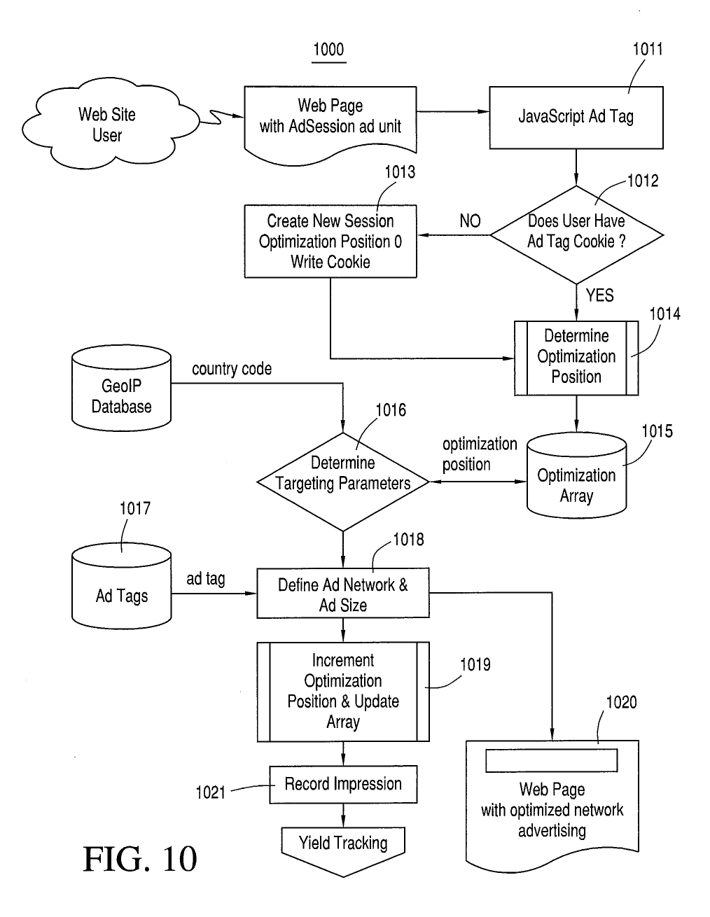

FIG. 10 illustrates an example of a method 1000 used to deliver an optimized Internet advertisement, once yield tracking and optimization have been completed, using computer system 100. In some embodiments, delivery module 140 (FIG. 1) can perform at least part of these activities. Method 1000 is merely exemplary and is not limited to the embodiments presented herein. Method 1000 can be employed in many different embodiments or examples not specifically depicted or described herein. In some embodiments, the activities, the procedures, and/or the processes of method 1000 can be performed in the order presented. In other embodiments, the activities, the procedures, and/or the processes of method 1000 can be performed in any other suitable order. In still other embodiments, one or more of the activities, the procedures, and/or the processes in method 1000 can be combined or skipped.

Method 1000 includes an exemplary activity 1011 of using an ad tag. Before activity 1011 is performed, the ad tag has been inserted into the HTML (or other code) of the web page being served. In activity 1011, a user has typed in a web site address into a browser (or clicked on a link on a different web page) to view a web page with one or more ad positions managed by computer system 100, and the browser has communicated to the web server the request for the web page with one or more ad positions managed by computer system 100.

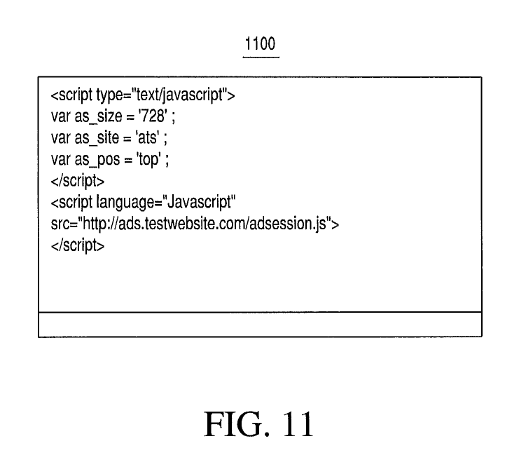

When a user is served the web page with one or more ad positions managed by computer system 100, those ad positions can contain, for example, a JavaScript ad tag that enables the initial connection to computer system 100. FIG. 11 illustrates an exemplary ad tag 1100, according to an embodiment.

As shown in FIG. 11, ad tag 1100 uses the JavaScript scripting language to establish the value of three variables, and then call the AdSession script located at “ads.abovetopsecret.com/adsession.js.” The variables are defined as:
as_size: This variable defines the size of the ad being requested as the first number of the typical pixel dimensions of the ad, in this case a 728×90 advertisement.
as_site: This variable is an abbreviated acronym defining the specific site, among all the other sites using computer system 100 (FIG. 1), for the purposes of revenue reporting, selection of advertising networks, and impression tracking.
as_pos: This variable defines the position on the page (top, middle, or bottom) of the advertisement being requested for the purposes of selecting the appropriate advertising network. Because some networks only allow advertisements at the top of a page, the value will be used to determine which advertisements from which networks are appropriate.

Computer system 100 (FIG. 1) is initiated by the call to the JavaScript contained in the external document adsession.js. Computer system 100 (FIG. 1) can use those variables, in combination with the end user's geographic location and session status, to select an optimized ad from the optimization array. The external adsession.js document activates a part of computer system 100 on the computer server, and returns the appropriate advertising network ad tag. In other embodiments, scripts written in languages other than JavaScript can be used for activity 1012.

Next, method 1000 in FIG. 10 includes an activity 1012 of determining if a session exists. In activity 1012, a web server can determine: (a) if the end user has previously received a cookie from computer system 100 (FIG. 1) (i.e., it is an active session); (b) if the end user has received a cookie more than, for example, 24 hours ago (i.e., it is an expired session); or (c) if the end user has never received a cookie. When the end user requests the web page with one or more ad positions managed by computer system 100 (FIG. 1), the cookie stored on the end user's computer for that web page is transmitted to the web server along with the request for the web page. In activity 1012, the web server determines if the end user's computer transmitted to the web server a cookie and, if a cookie exists, transmits the cookie to the computer server and the computer server determines the status of the end user's session. In other embodiments, the web server can determined the status of the end user's session.

The presence of the cookie from computer system 100 (FIG. 1) defines the status of the “session,” which is typical Internet nomenclature that enables web applications to be aware of the status and specifics of any given users between the pages they view. In connection with computer system 100 (FIG. 1), a cookie can be used to remember the user's position in the optimization array for each advertisement size.

Subsequently, method 1000 in FIG. 10 includes an activity 1013 of initiating new session. If the end user has no active session, or has an expired session, computer system 100 (FIG. 1) can create a new cookie, and assign an initial value of zero to the end user's position in each of the three optimization arrays for each of the three advertisement sizes. This cookie can be transmitted by the web server to the end user's computer and stored in the memory of the end user's computer. In some examples, the computer server can provide the cookie to the web server.

The cookie used to define a session in AdSession can be, for example, a simple random combination of alphanumeric characters, and contains no personally identifying information. The value of the cookie identifies session data stored on the computer server's file system, unique to each end user, and contains the three optimization arrays for each advertisement size. In some examples, the combination of cookie value and session data can be used to retain an optimization array for each user, and record which ads from each of the three arrays have been given to the end user.

Next, method 1000 in FIG. 10 includes an activity 1014 of determining an optimization position. If an active session exists, the computer server can combine the session data of the end user (e.g., their position in the optimization array) with the previously defined “as_size” variable to determine which ad position from which optimization array to use. In the case of a new end user with a newly created session in this example, it will be position zero from the 728×90 array.

Method 1000 in FIG. 10 continues with activities 1015 through 1018 of obtaining an ad tag. Activities 1015 through 1018 utilize the end user's optimization array (stored on the computer server as part of their session data) for the requested ad size, and combines that information with the targeting parameters that include, for example, the user's country code, the as_pos JavaScript parameter, and the as_site JavaScript parameter. With this information, delivery module 140 (FIG. 1) searches for the next qualifying advertising network, in sequence, from the end user's optimization array.

In some examples, the computer server can use a location determination routine to determine the user's country code. In one example, the computer server can use the GeoIP software manufactured by MaxMind, Inc. of Waltham, Mass.

In one example, three ad networks, “NET,” “NET2,” and “NET3” can be available, but only “NET” and “NET3” are qualified to deliver advertising to an end user on site “ats” for position “top” from a country code of “US” (United States). Delivery module 140 (FIG. 1) can look for the next qualifying network, in sequence, passing up any instances of “NET2” in the end user's optimization array until it finds a position defined as “NET” or “NET3.” Once an appropriate advertising network is located, delivery module 140 (FIG. 1) will negate that position in the end user's optimization array, preventing it from being delivered again in future impression requests.

Additional targeting parameters can include:
as_force: This parameter is used to force the display of a specific advertising network. As some networks specifically request priority or premium positions on specific pages, this parameter allows the computer server to force a specific network to appear, while still recording that impression and negating the next instance of that network from the end user's optimization array.
as_page: This parameter is useful because some advertising networks offer a distinct set of ad tags intended for specific pages, such as the web site's home page, specific editorial pages, or other top priority pages. This parameter allows the computer server to define the page type (e.g., home page, specific editorial page, etc.).
as_user: This parameter is used to define data specific to a user-type on the web site using computer system 100 (FIG. 1). The data may define whether or not a user is logged into the web site, specific preferences, or other information useful for targeting advertisements.
as_type: This parameter, when enabled for a web site, is used to allow advanced display advertisements that include interactive size expansion, video elements, audio elements, or other enhanced rich media attributes. This parameter is useful as some web site operators may want to limit these types of advertisements to specific pages.
as_array: This parameter, when active, forces the computer server to bypass the recording of an advertising network impression in the end user's optimization array. Typically used in conjunction with the as_force parameter, this parameter is useful when integrating advertising networks that use real time bidding or other methods of guaranteeing a paid impression, on specific areas of web site pages.
as_skin: This parameter, when enabled for specific web sites, enables the computer server to optimize and record the delivery of “skin” advertisements that wrap or surround the content of a web site's pages.
as_custom: This parameter, when enabled for specific web sites, defines the size of custom advertising units beyond the standard three sizes. A typical custom size is often the “half page” ad with pixels dimensions of 300 side by 600 tall.
as_mobi: This parameter, when enabled for web sites enhanced for mobile devices, forces the computer server to select ad tags only from the advertising networks that are optimized for delivery to mobile devices.
as_pre: This parameter, when enabled for video optimization, forces the computer server to focus on ad tags and related video components for the optimization of pre-roll video ads in video players that integrate computer system 100 (FIG. 1).
as_over: This parameter, when enabled for video optimization, forces the computer server to focus on ad tags and related video components for the optimization of mid-roll overlay ads in video players that integrate computer system 100 (FIG. 1).

If a “power user” exhausts all the available impressions as defined by their prioritization array, ads from qualifying advertising networks will be randomly selected, with weighted priority given to each position of each advertising network, as defined by optimization process 800 of FIG. 8. The same activities 1015 through 1018 can be used, including all targeting parameters, except that the end user's optimization array is not used or updated.

In some examples, all session data expires 24 hours after initially set, and an end user revisiting a web site using computer system 100 (FIG. 1) outside that time frame receives a new session.

Next, method 1000 of FIG. 10 includes activities 1019 and 1021. Activity 1019 responds to the actions taken in activity 1018, and records a “served” indication for the optimization position used in the end user's optimization array. For example, if the position previously contained the value “NET3,” which indicates an advertisement from third advertising network, NET3, was delivered, the value is changed to “served.” This marking tells the computer server that an ad from that position in the array was delivered to the end user.

Activity 1021 records the impression for use in yield tracking module 130 (FIG. 1) by incrementing the daily total for the appropriate ad size from the network used. In this example, the database record corresponding to the current day, for ad size 728×90 and for advertising network NET3, can be incremented by a value of one. Required information for the tracking of any other custom targeting parameters can also be recorded in activity 1021.

Method 1000 in FIG. 10 also includes an activity 1020 (occurring after activity 1018) of displaying the ad. Activity 1020 is the output or return to the end user of the ad tag selected in activities 1015 through 1018. At this point, the systems of the advertising networks take over and select the appropriate ad for the specific end user.

Under a full load of an average of fifty ad tags, for example, being delivered every second, the efficiency of this method can present an optimized ad tag to the end user in an average of 0.0015 seconds, effectively no measurable latency.

“Server” as used herein, can refer to a single computer, a single server, or a cluster or collection of servers. Typically, a cluster or collection of servers can be used when the demands by client computers (e.g., the end users) are beyond the reasonable capability of a single server or computer. In many embodiments, the servers in the cluster or collection of servers are interchangeable from the perspective of the client computers.

In some examples, a single server (i.e., an computer server) can include each of optimization module 110, delivery visualization module 120, yield tracking module 130, and delivery module 140, as shown in FIG. 1. In other examples, a first server can include a first portion of these modules, and one or more second servers can include a second, possibly overlapping, portion of these modules. In these examples, the computer server can comprise the combination of the first server and the one or more second servers.

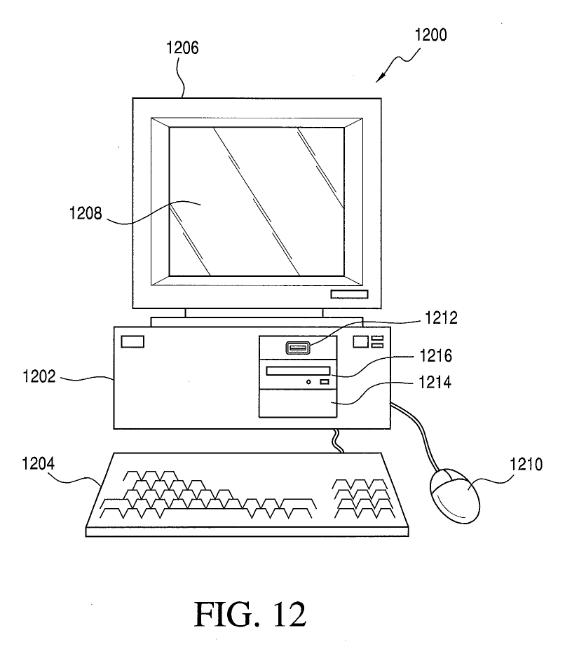

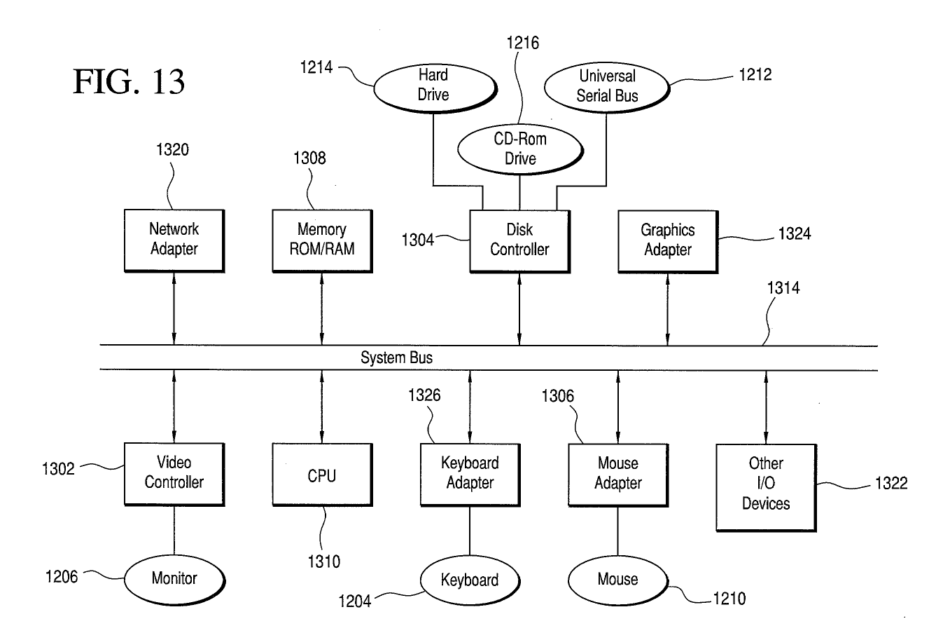

FIG. 12 illustrates a server 1200 that is suitable for implementing an embodiment of at least a portion of a computer system used to implement computer system 120 described herein. Server 1200 includes a chassis 1202 containing one or more circuit boards (not shown), a USB (universal serial bus) port 1212, a Compact Disc Read-Only Memory (CD-ROM) and/or Digital Video Disc (DVD) drive 1216, and a hard drive 1214. A representative block diagram of the elements included on the circuit boards inside chassis 1202 is shown in FIG. 13. A central processing unit (CPU) 1310 in FIG. 13 is coupled to a system bus 1314 in FIG. 13. In various embodiments, the architecture of CPU 1310 can be compliant with any of a variety of commercially distributed architecture families.

System bus 1314 also is coupled to memory 1308 that includes both read only memory (ROM) and random access memory (RAM). Non-volatile portions of memory 1308 or the ROM can be encoded with a boot code sequence suitable for restoring server 1200 (FIG. 12) to a functional state after a system reset. In addition, memory 1308 can include microcode such as a Basic Input-Output System (BIOS). In some examples, processor 160 of FIG. 1 can include CPU 1310. In the same or different embodiments, storage device 150 of FIG. 1 can include a USB drive in USB port 1212, on a CD-ROM or DVD in CD-ROM and/or DVD drive 1216, hard drive 1214, and/or memory 1308 (FIG. 13).

In the depicted embodiment of FIG. 13, various I/O devices such as a disk controller 1304, a graphics adapter 1324, a video controller 1302, a keyboard adapter 1326, a mouse adapter 1306, a network adapter 1320, and other I/O devices 1322 can be coupled to system bus 1314. Keyboard adapter 1326 and mouse adapter 1306 are coupled to a keyboard 1204 (FIGS. 12 and 13) and a mouse 1210 (FIGS. 12 and 13), respectively, of server 1200 (FIG. 12). While graphics adapter 1324 and video controller 1302 are indicated as distinct units in FIG. 13, video controller 1302 can be integrated into graphics adapter 1324, or vice versa in other embodiments. Video controller 1302 is suitable for refreshing a monitor 1206 (FIGS. 12 and 13) to display images on a screen 1208 (FIG. 12) of server 1200 (FIG. 12). Disk controller 1304 can control hard drive 1214 (FIGS. 12 and 13), floppy disc drive 1212 (FIGS. 12 and 13), and CD-ROM or DVD drive 1216 (FIGS. 12 and 13). In other embodiments, distinct units can be used to control each of these devices separately.

Although many other components of server 1200 (FIGS. 12 and 13) are not shown, such components and their interconnection are well known to those of ordinary skill in the art. Accordingly, further details concerning the construction and composition of server 1200 and the circuit boards inside chassis 1202 (FIG. 12) need not be discussed herein.

When server 1200 in FIG. 12 is running, program instructions stored on stored on a USB drive in USB port 1212, on a CD-ROM or DVD in CD-ROM and/or DVD drive 1216, on hard drive 1214, or in memory 1308 (FIG. 13) are executed by CPU 1310 (FIG. 13). A portion of the program instructions, stored on these devices, can be suitable for carrying out the systems and methods described previously with respect to FIGS. 1-11.

As referenced in the array of targeting parameters, the advantages of the delivery method of computer system 100 (FIG. 1) is that it transcends web site pages into content designed for mobile devices and online video streams. As new technologies or asset delivery modules evolve that deliver content to Internet end users, whether funded partially or in whole by advertising, the core method of computer system 100 (FIG. 1) can easily accommodate new content by adding new targeting parameters.

Currently, all optimization is delivered from a specific Internet domain. However, computer system 100 (FIG. 1) accommodates and can take advantage of a “White Label” process enabling web sites using computer system 100 (FIG. 1) to do so from their own domain name. For example, a web site named “BigContentSite.com” that elects to use this option would access the adsession.js programming via this URL: ads.bigcontentsite.com/adsession.js.

The advantage of delivering optimized advertisements through the actual domain name of a web site can be significant, as the AdSession cookie will show as having originated from BigContentSite.com to the end user, thus not qualifying as a “third party” cookie. A small percentage of end users have configured their web browsers to deny third party cookies, and this White Label method bypasses those concerns. Because no personal information is referenced by or stored in the cookie, there are also no privacy concerns.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the method described above in relation to FIG. 10 may be comprised of many different activities, procedures and be performed by many different modules, in many different orders, that any element of figure one may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system configured to determine two or more advertisements to be displayed at one or more web sites, the system is further configured to be performed using one or more central processing units, the system comprising:
a delivery visualization module configured to allow a user to review one or more prioritization parameters and prior advertisement delivery data, the delivery visualization module is further configured to allow the user to adjust the one or more prioritization parameters;
a yield tracking module configured to allow the user to enter information into the system related to the one or more prioritization parameters and the prior advertisement delivery data;
an optimization module configured to create an ordered list of two or more advertisement networks based on the one or more prioritization parameters; and
a delivery module configured to determine, based on the ordered list of the two or more advertisement networks, at least one advertising network of the two or more advertisement networks to provide at least one advertisement to display at a first web page of a web site of the one or more web sites,
wherein:
the two or more advertisements comprise the at least one advertisement.

2. The system of claim 1, wherein:
the one or more prioritization parameters comprise: a cost per advertisement, a frequency cap, and a fill rate.

3. The system of claim 1, wherein:
the optimization module configured to create the ordered list of the two or more advertisement networks using a factor value to prioritize a first one of the two or more advertisement networks when a cost per advertisement for the first one of the two or more advertisement networks is larger than the factor value.

4. The system of claim 1, further comprises:
a storage unit,
wherein:
the optimization module is configured to store the ordered list of the two or more advertisement networks in the storage unit.

5. The system of claim 1, wherein:
the optimization module is further configured to automatically create the ordered list of the two or more advertisement networks at a predetermined interval.

6. The system of claim 5, wherein:
the predetermined interval is once a day.

7. The system of claim 1, wherein:
the one or more web sites have an ad tag embedded into the first web page of the web site of the one or more web sites; and
the delivery module is configured to determine, at least partially based upon the ad tag, which of the at least one advertising network of the two or more advertisement networks to provide to display at the first web page of the web site of the one or more web sites.

8. The system of claim 7, wherein:
the ad tag comprises a computer script.

9. The system of claim 7, wherein:
the delivery module is further configured to determine, at least partially based upon a geographic location of a computer of a visitor and a session status, which of the at least one advertising network of the two or more advertisement networks to provide to display at the first web page of the web site of the one or more web sites; and
the computer of the visitor requested service of the first web page of the web site of the one or more web sites.

10. A method to facilitate display of two or more advertisements at one or more web sites, the method comprising:
using a server to create a first ordered list of the two or more advertisements;
storing the first ordered list of the two or more advertisements in a memory associated with the server; and
using the server to determine which of the two or more advertisements to display at the one or more web sites based on the first ordered list of the two or more advertisements.

11. The method of claim 10, wherein:
the first ordered list of the two or more advertisements comprises:
a second ordered list of identification information for two or more advertisement networks; and
the two or more advertising networks provide the two or more advertisements.

12. A method to determine two or more advertisements to be displayed at one or more web sites, the method comprising:
facilitating entering into a server information related to one or more prioritization parameters and prior advertisement delivery data;
facilitating review by a user of the one or more prioritization parameters and the prior advertisement delivery data on the server;
facilitating adjustment of the one or more prioritization parameters;
using the server to create an ordered list of two or more advertisement networks based on the one or more prioritization parameters; and
using the server to determine, based on the ordered list of two or more advertisement networks, at least one advertising network of the two or more advertisement networks to provide at least one advertisement to display at a first web page of a web site of the one or more web sites,
wherein:
the two or more advertisements comprise the at least one advertisement.

13. The method of claim 12, wherein:
the one or more prioritization parameters comprise: a cost per advertisement, a frequency cap, and a fill rate.

14. The method of claim 12, wherein:
using the server to determine, based on the ordered list of two or more advertisement networks, the at least one advertising network comprises:
using the server to create the ordered list of the two or more advertisement networks using a factor value to prioritize a first one of the two or more advertisement networks when a cost per advertisement for the first one of the two or more advertisement networks is larger than the factor value.

15. The method of claim 12, further comprises:
storing the ordered list of the two or more advertisement networks in a storage unit.

16. The method of claim 12, wherein:
using the server to determine, based on the ordered list of the two or more advertisement networks, the at least one advertising network comprises:
automatically using the server to determine, based on the ordered list of the two or more advertisement networks, the at least one advertising network of the two or more advertisement networks to provide the at least one advertisement to display at the first web page of a web site of the one or more web sites at a predetermined interval.

17. The method of claim 12, wherein:
using the server to determine, based on the ordered list of the two or more advertisement networks, the at least one advertising network comprises:
automatically using the server to determine, based on the ordered list of the two or more advertisement networks, the at least one advertising network of the two or more advertisement networks to provide the at least one advertisement to display at the first web page of a web site of the one or more web sites once a day.

18. The method of claim 14, further comprising:
facilitating embedded into the first web page of the web site of the one or more web sites an ad tag; and
using the server to determine, based on the ordered list of the two or more advertisement networks, the at least one advertising network comprises:
using the server to determine, based on the ordered list of the two or more advertisement networks and the ad tag, the at least one advertising network of the two or more advertisement networks to provide the at least one advertisement to display at the first web page of the web site of the one or more web sites.

19. The method of claim 18, wherein:
the ad tag comprises a computer script.

20. The method of claim 14, wherein:
using the server to determine, based on the ordered list of the two or more advertisement networks, the at least one advertising network comprises:
using the server to determine, based on the ordered list of the two or more advertisement networks, a geographic location of a computer of a visitor, and a session status, at least one advertising network of the two or more advertisement networks to provide the at least one advertisement to display at the first web page of the web site of the one or more web sites; and
the computer of the visitor requested service of the first web page of the web site of the one or more web sites.
